(19) United States
(12) Patent Application Publication
(10) Pub. No.: US 2005/0104502 A1
(43) Pub. Date: May 19, 2005

(54) Glass bulb for use in cathode-ray tube for projection TV and method of manufacturing the same

(76) Inventors: Kazuo Otsuka, Saitama (JP); Toshimitsu Matsuo, Saitama (JP); Ryoichi Miyahara, Saitama (JP)

Correspondence Address: BIRCH STEWART KOLASCH & BIRCH, PO BOX 747, FALLS CHURCH, VA, 22040-0747, US

(21) Appl. No.: 10/790,083

(22) Filed: Mar. 2, 2004

(30) Foreign Application Priority Data
Nov. 17, 2003 (JP) 2003-386967

(51) Int. Cl. H01J 29/86

(52) U.S. Cl. 313/477 R

(57) ABSTRACT

A glass bulb for use in a projection TV cathode-ray tube includes a face part having a fluorescent film, wherein the face part includes: a light-transmitting region that contains no contaminant having an effective diameter W of at least a defective reference value φ; and a region extending from the surface of the fluorescent film in the light-travel direction, which is located within a reference depth TS and only contains a contaminant having an effective diameter W of at most a measurement reference value φ′, wherein the defective reference value φ is from 0.15 to 0.35 mm; the measurement reference value φ′ is from 0.07 to 0.15 mm; and the reference depth TS is from 2.6 to 4.0 mm. Such a glass bulb can be used for a cathode-ray tube in a wide-screen projection TV and can be prevented from causing a defective projection image on a screen.

### BACKGROUND OF THE INVENTION

1. Field of the Invention

The invention relates to a glass bulb for use in a cathode-ray tube for projection and, particularly, to a glass bulb for use in a cathode-ray tube having an improved face part in which the contaminant has no adverse effect on the displayed image.

2. Description of the Prior Art

Referring to FIG. 9, a general system of a projection TV includes three cathode-ray tubes 20 (20R, 20G, 20B) for R, G and B, respectively, lens assemblies 21 each located in front of each cathode-ray tube 20, a reflecting mirror 22 for reflecting projection light from each lens assembly 21, and a screen 23 for displaying the light reflected from the mirror 22. The three cathode-ray tubes 20R, 20G and 20B independently produce a red image (R), a green image (G) and a blue image (B), respectively, and these three primary color images are combined on the screen 23 to form a certain full color image.

Referring to FIGS. 10A and 10B, the cathode-ray tube 20 includes a rectangular face part 24, a substantially pyramid-shaped funnel part 25, and a neck part 26, which are independently produced. The face part 24, the funnel part 25 and the neck part 26 are welded together on the respective weld surfaces 27 and 28 to form a glass bulb for use in a cathode-ray tube. An electron gun is then attached to the neck part 26 of the glass bulb to form the cathode-ray tube 20.

In the face part 24, the front surface 24a of the top is polished to a smooth finish, and a fluorescent film for any of R, G and B is formed on the back surface 24b of the top. An electron beam is emitted from the electron gun and strikes the fluorescent film, which emits light of a specific color. The emitted light is directed to and expanded by the lens assembly 21 (see FIG. 10(c)).

### SUMMARY OF THE INVENTION

The cathode-ray tube having such a structure can contain a contaminant such as an impurity crystal (a stone) and a bubble between the back and front surfaces of the face part. Such a contaminant can inhibit the passage of light to cause a defect in the image or to cause a shade in the color image on the screen.

For the purpose of solving such a problem, the generation of the contaminant may be suppressed by control of the furnace temperature from the glass melting step to the press molding step, control of the materials or any other technique. It is, however, very difficult to completely prevent the contaminant.

In these days, the screen of the projection TV has been enlarged, and more sharpened images have been created, such as high vision images. Under such circumstances, even a small contaminant that conventionally presents no problem can cause the above adverse effect. Thus, any appropriate improvements should be made; otherwise the rate of defective products can be significantly raised so that the production efficiency can significantly be reduced.

The invention has been made based on the above problem. It is an object of the invention to provide a glass bulb that can be used for a cathode-ray tube in a wide-screen projection TV or can be used for a cathode-ray tube to create sharp images and that can be prevented from causing a defective projection image on a screen. It is another object of the invention to provide a method of manufacturing an improved glass bulb for use in a cathode-ray tube, which is prevented from causing a defective projection image on a screen.

In order to achieve the above objects, the inventors have made active investigations and found the following things: (a) Concerning the contaminant contained in the glass bulb for use in the cathode-ray tube, the quality control only focusing on the size of the contaminant can case a useless reduction in product yield and can only worsen the production efficiency; (b) The adverse effects of the face part contaminant on the projection image differ between the cathode-ray tubes for red, green and blue images; (c) More specifically, the red and green images can be seen sharply, while the blue image softly, and even if the quality control of the blue image cathode-ray tube is not as severe as that of the red or green image cathode-ray tube, the blue tube can have no adverse effect on the projection image; and (d) The contaminants in the face part have different effects on the image, depending on their location in the depth direction, and the contaminant in the vicinity of the fluorescent film surface can be particularly harmful. Based on these findings, the inventors have made further investigations and completed the invention.

In a first aspect, the invention is directed to a glass bulb for use in a cathode-ray tube for a projection TV for forming a red or green image, comprising a face part having a fluorescent film, wherein the face part includes: a light-transmitting region that contains no contaminant having an effective diameter W of at least a defective reference value φ; and a region extending from the surface of the fluorescent film in the light-travel direction, which is located within a reference depth TS and only contains a contaminant having an effective diameter W of at most a measurement reference value φ′, and the defective reference value φ is from 0.15 to 0.35 mm; the measurement reference value φ′ is from 0.07 to 0.15 mm; and the reference depth TS is from 2.6 to 4.0 mm.

In a second aspect, the invention is directed to a glass bulb for use in a cathode-ray tube for forming a blue image and for use in combination with the glass bulb in the first aspect, comprising a face part whose light-transmitting region contains no contaminant having an effective diameter W of at least a defective reference value φ, wherein the defective reference value φ is from 0.15 to 0.35 mm. If the three glass bulbs are used in combination according to the first and second aspects, an unsightly shade on a screen can be prevented without a particular increase in the manufacturing cost.

In a third aspect, the invention is directed to a glass bulb for use in a cathode-ray tube for a projection TV for forming a red or green image, comprising a face part having a fluorescent film, wherein the face part includes: a light-transmitting region that contains no contaminant having an effective diameter W of at least a first reference value φ1; and a region extending from the surface of the fluorescent film in the light-travel direction, which is located within a reference depth TS and contains no contaminant having an effective diameter W of at least a second reference value φ2, and the first reference value φ1 is from 0.15 to 0.3 mm; the second reference value φ2 is from 0.10 to 0.15 mm; and the reference depth TS is from 2.6 to 4.0 mm.

In a fourth aspect, the invention is directed to a glass bulb for use in a cathode-ray tube for a projection TV for forming a blue image, comprising a face part having a fluorescent film, wherein the face part includes: a light-transmitting region that contains no contaminant having an effective diameter W of at least a third reference value φ3; and a region extending from the surface of the fluorescent film in the light-travel direction, which is located within a reference depth TS and contains no contaminant having an effective diameter W of at least a fourth reference value φ4, and the third reference value φ3 is from 0.25 to 0.35 mm; the fourth reference value φ4 is from 0.2 to 0.3 mm provided that φ4 is smaller than φ3 (φ4<φ3); and the reference depth TS is from 2.6 to 4.0 mm.

In each aspect of the invention, the contaminant means a matter that can inhibit light from travelling in straight lines from the surface of the fluorescent film and is typically a bubble or an impurity crystal. The effective diameter means a diameter of a hypothetical circle, which is obtained by calculation so as to have an area equal to the area occupied by the contaminant inhibiting the straight travel of the light. The region that extends from the surface 1a of the fluorescent film of the face part in the light-travel direction and is located within a reference depth TS means the area indicated by diagonal lines in FIG. 8. The reference depth TS is preferably measured by shifting the focus position of a magnifier 5 in the forward or backward direction of the light perpendicular to the front face 1b of the face part (the end surface in the light travel) (see FIG. 8).

In each aspect of the invention, the reference depth TS may be determined based on the focus setting of the lens assembly placed in front of the cathode-ray tube and is in the range from 2.6 to 4.0 mm. As a result of investigations, the inventors have found that the effect of any contaminant in the face part decreases as the distance from the contaminant to the reference depth increases and that the contaminant even with a certain size cannot affect the image if it is located far from the surface of the fluorescent film.

In each aspect of the invention, the contaminant should be managed or controlled in the region from the surface of the fluorescent film to a reference depth TS (of 2.6 to 4.0 mm). In each aspect, the region from the surface of the fluorescent film to a depth of 4.0 mm may uniformly be managed. The effect of the contaminant on the image increases as the contaminant becomes closer to the surface of the fluorescent film, and thus it is effective to more strictly manage the region from the surface of the fluorescent film to a depth of 2.6 mm. In the specification, the term “depth” means a depth from the surface of the fluorescent film in the light-travel direction.

In each aspect of the invention, any contaminant having an effective diameter of a measurement reference value φ′ or less presents no problem, no matter how it is located. The measurement reference value φ′ should be 0.1 mm, preferably 0.09 mm, more preferably 0.07 mm. In each aspect of the invention, therefore, any contaminant having an effective diameter of 0.1 mm or less (preferably 0.09 mm or less, more preferably 0.07 mm or less) is allowed to exist. This feature may also be included in any aspect of the invention below.

In a fifth aspect, the invention is directed to a method of manufacturing a glass bulb for use in a cathode-ray tube for a projection TV, comprising: a first step of determining the size of a contaminant in a light-transmitting region of a face part of the glass bulb and determining the position of the contaminant in a two-dimensional coordinate system; a second step of searching, in another coordinate direction, the contaminant located in the two-dimensional coordinate system, in order to determine the depth position of the contaminant in a three-dimensional coordinate system; and a third step of determining the use of the face part based on the determined depth position.

In a sixth aspect, the invention is directed to a method of manufacturing a glass bulb for use in a cathode-ray tube for a projection TV, comprising: a first step of approximately determining the size of a contaminant in a light-transmitting region of a face part of the glass bulb and determining the position of the contaminant in a two-dimensional coordinate system; a second step of searching, in another coordinate direction, the contaminant located in the two-dimensional coordinate system, in order to determine the depth position of the contaminant in a three-dimensional coordinate system and to precisely determine the size of the contaminant; and a third step of determining the use of the face part based on the determined depth position and the precisely determined size.

In each aspect of the invention, the glass preferably comprises 45 to 65% by mass of SiO₂, 0 to 4% by mass of Al₂O₃, 0 to 3% by mass of MgO, 0 to 3% by mass of CaO, 5 to 14% by mass of SrO, 8 to 18% by mass of BaO, 3 to 12% by mass of ZnO, 1 to 6% by mass of Na₂O, 5 to 13% by mass of K₂O, 0.1 to 3% by mass of Li₂O, 0 to 3% by mass of ZrO₂, 0 to 3% by mass of TiO₂, 0 to 3% by mass of CeO₂, 0 to 2% by mass of Sb₂O₃, and 0 to 2% by mass of P₂O₅. The glass preferably has an X-ray absorption coefficient of 34 cm⁻¹ or more at a wavelength of 0.6 Å.

According to the invention as shown above, the glass bulb can be used for the cathode-ray tube in a wide-screen projection TV or can be used for the cathode-ray tube to create sharp images and can be prevented from causing a defective projection image on a screen. The inventive method can produce an improved glass bulb for a cathode-ray tube, which is prevented from causing a defective projection image on a screen.

### BRIEF DESCRIPTION OF THE DRAWINGS

FIG. 1 is a flowchart showing a manufacturing method according to a first embodiment of the invention;

FIGS. 2A to 2C are schematic diagrams showing the process of step ST1 in FIG. 1;

FIGS. 3A and 3B are schematic diagrams showing the process of step ST1 in FIG. 1;

FIGS. 4A and 4B are schematic diagrams showing the processes of steps ST7 and ST6 in FIG. 1;

FIGS. 5A to 5D show a method of determining the depth;

FIG. 6 is a flowchart showing a manufacturing method according to a second embodiment of the invention;

FIG. 7 shows evaluation tables for use in the second embodiment of the invention;

FIG. 8 is a diagram showing a principle in the invention; and

FIGS. 9 and 10A to 10C are diagrams showing basic technology.

### DETAILED DESCRIPTION OF THE INVENTION

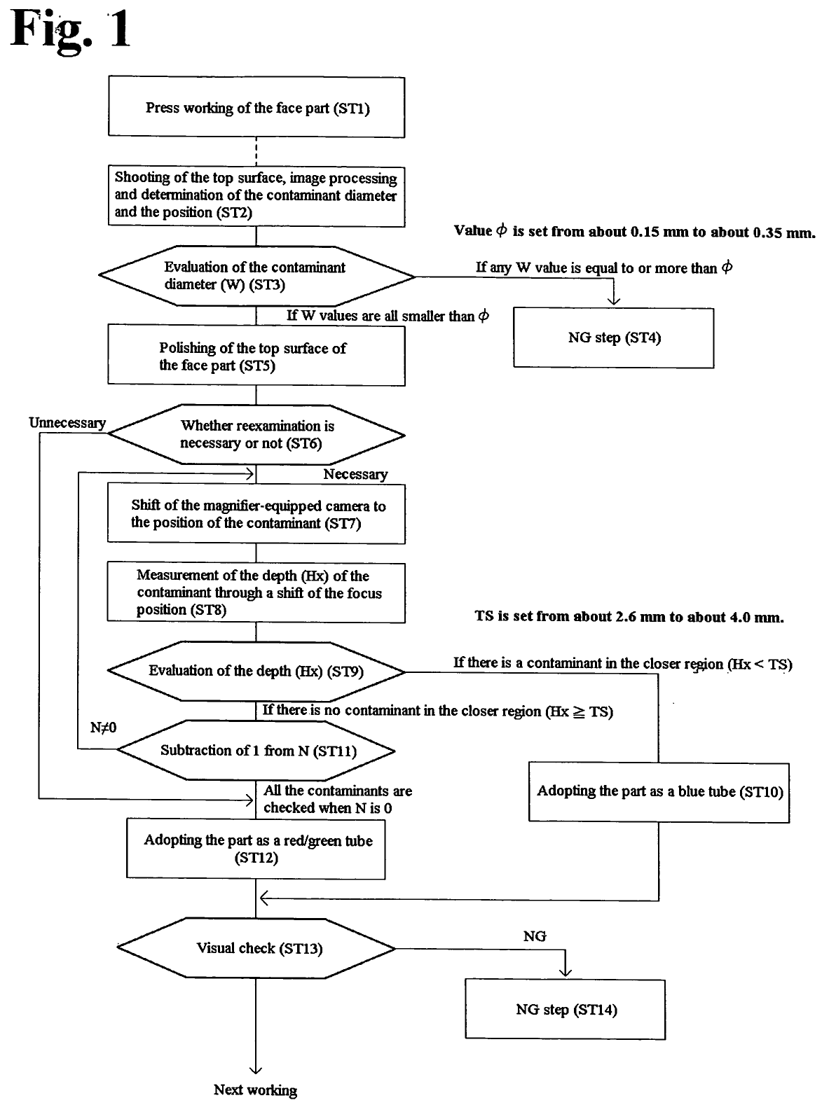

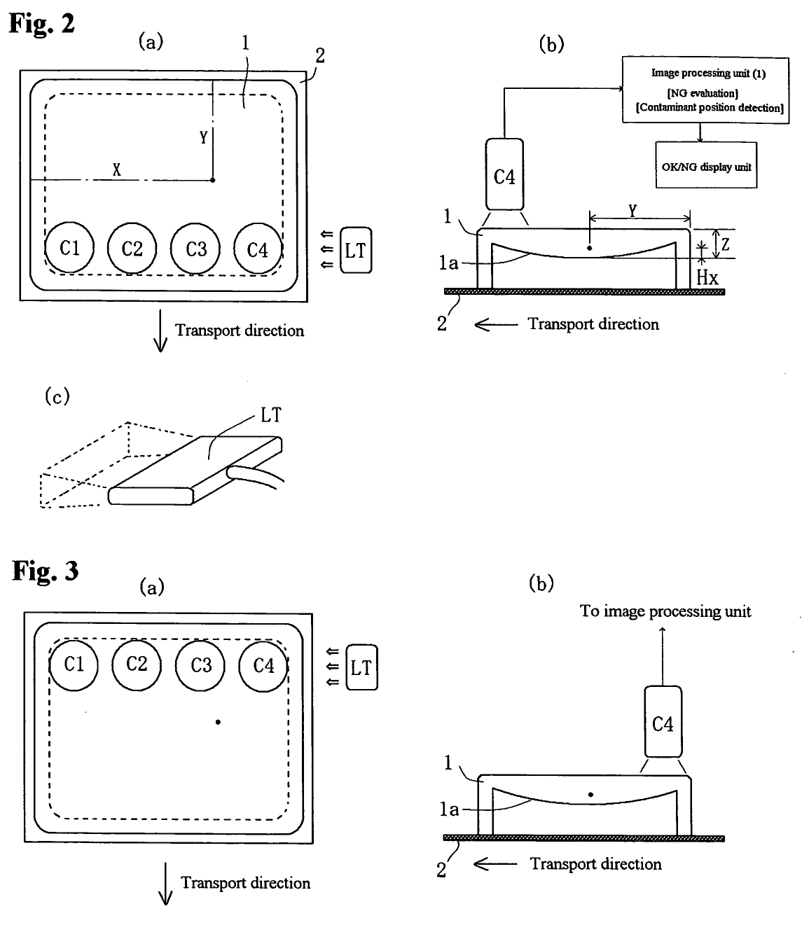

The invention will be further described in detail in embodiments below. FIG. 1 is a flowchart showing a first embodiment of the inventive method of manufacturing the glass bulb for the cathode-ray tube; and FIGS. 3A and 3B, FIGS. 4A and 4B, and FIGS. 5A to 5D are schematic diagrams showing processes in the method. This embodiment includes: forming a face part by press working (ST1); then shooting the surface of the top of the face part with a CCD camera; and using computer image processing to determine the effective diameter W of a contaminant(s) and to determine the coordinate position (X, Y) of each contaminant (ST2). FIGS. 2A, 2B, 3A, and 3B show the processes, wherein FIGS. 2A and 3A are each a plan view, and FIGS. 2B and 3B are each a right-side view.

Referring to the figures, the face part 1 is placed on a black sheet 2 and transported while the surface of the top of the face part 1 is shot using four CCD cameras C1 to C4. A directional inspection beam with a half-value width of 5 to 10° is projected onto the center of the glass wall in a horizontal direction perpendicular to the direction of transport of the face part 1. Referring to FIG. 2C, the inspection beam is emitted from a light-emitting unit LT. In this embodiment, the test surface extending over the whole width of the face part 1 is shot with the four CCD cameras C1 to C4, and this operation is repeated four times so that the test surface is shot over the whole region of the face part 1 in the transport direction. Herein, the test surface substantially extends over the whole glass region through which the emitted light passes from the surface 1a of the fluorescent film of the face part 1.

As shown above, the inspection beam is applied to a side of the face part 1 placed on the black sheet 2. Thus, any contaminant such as a bubble and an impurity crystal in the glass wall of the face part 1 is detected as a whitish spot. Thus, an image processing program P1 is started to determine the coordinate position (X, Y) of the contaminant and to determine the equivalent diameter W (hereinafter referred to as “contaminant diameter W”) of the hypothetical circle, into which the shape of the contaminant is converted by calculation (ST2). If plural contaminants are detected, the contaminant diameter W and the coordinate position (X, Y) are stored with respect to a contaminant or contaminants of a non-negligible size. Herein, the minimum contaminant diameter of the non-negligible contaminant is about 0.09 mm.

After step ST2 is completed, all the stored contaminant diameters W are evaluated (ST3), and if any of the values is equal to or more than the defective reference value φ, the face part is subjected to a NG step (ST4). If no contaminant has a value of at least the defective reference value φ, the surface of the top of the face part 1 is subjected to a polishing step (ST5). The setting of the defective reference value φ is important. In the invention, the defective reference value φ may be handled depending on the depth of the contaminant. It has been shown that the defective reference value φ for rejecting defective items is appropriately from about 0.15 to about 0.35 mm.

After the polishing step ST5 is completed, the face part 1 is evaluated whether it needs a close examination or not (ST6). If the face part 1 completely has no harmful contaminant, it is subjected to step ST12, but if not, the close examination is carried out.

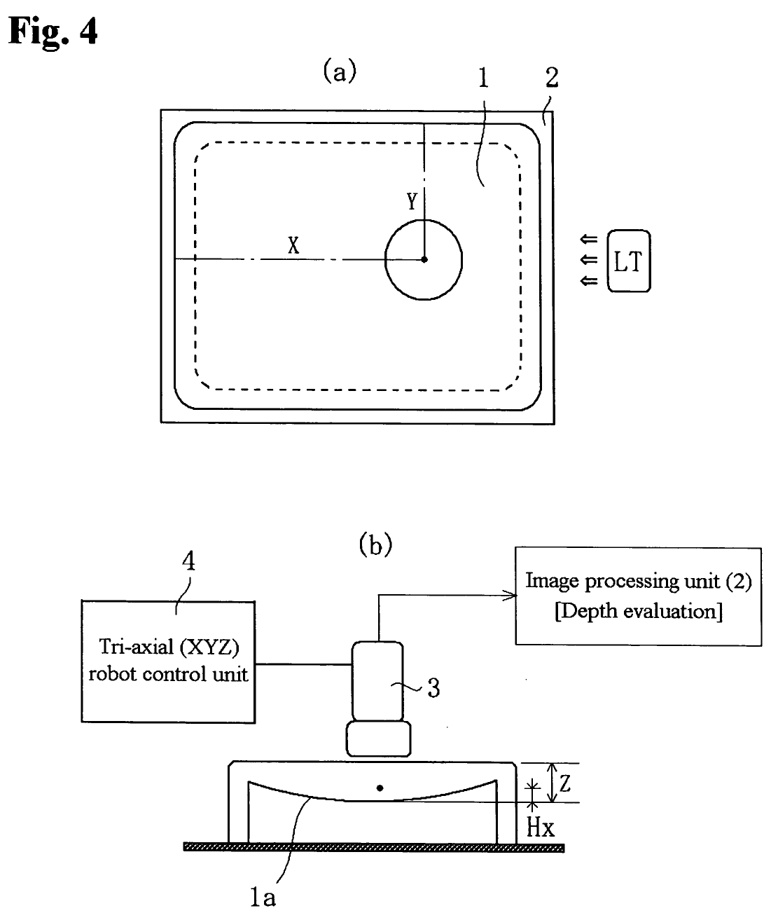

FIGS. 4A and 4B show the close examination, wherein FIG. 4A is a schematic plan view, and FIG. 4B is a schematic right-side view. Referring to the figures, the face part 1 is placed on the black sheet 2, and a directional inspection beam with a half-value width of 5° to 10° is horizontally projected to the center of the glass wall of the face part 1. The close examination step is performed using a CCD camera 3 equipped with a magnifier such as a microscope. The CCD camera 3 is manipulated by a tri-axial robot 4 so that it can move to any position in the horizontal directions (X and Y directions) and in the perpendicular direction (Z direction).

The face part 1 has a spherical surface with a radius of curvature of about 350 mm, on which the fluorescent film is formed. In such a structure, the thickness (Z) of the glass at each coordinate position (X, Y) is previously registered in a computer. When the coordinate position (X, Y) of the contaminant is determined in step ST2, the tri-axial robot 4, which can determine the focus position for the target based on the thickness (Z) data registered in the computer, moves in such a manner that the magnifier focuses on the deepest portion (X, Y, Z) at the horizontal position of the contaminant (ST7). FIG. 4B shows such a state, in which the magnifier placed immediately above the contaminant focuses on the deepest portion (X, Y, Z) of the glass wall, wherein the contaminant is actually located at the position (X, Y, Z-Hx).

Subsequently, the focus position of the magnifier is automatically shifted from the base position shown in FIG. 4B in the upward perpendicular direction, so that the depth Hx of the contaminant from the surface 1a of the fluorescent film is measured (ST8). The distance covered by the shift of the focus position may be set as appropriate and should at least sufficiently exceed the reference depth TS as described below.

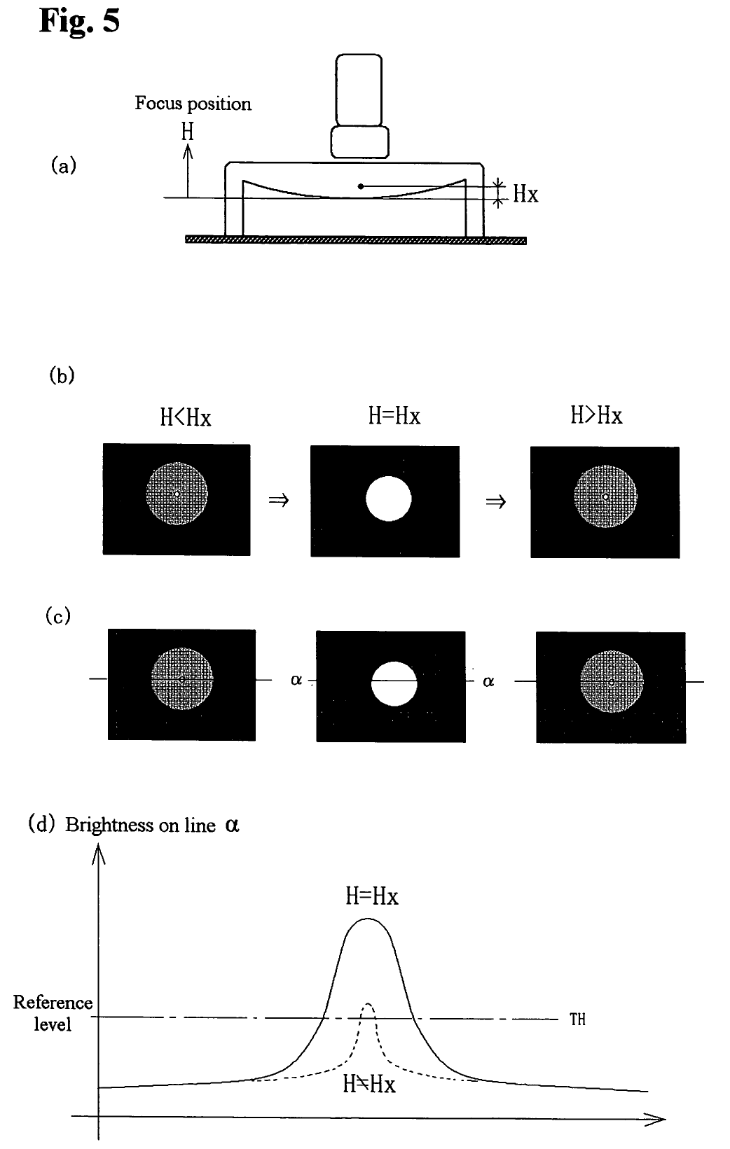

FIG. 5B schematically shows the CCD camera image when the focus position is shifted. If the focus position H is lower than Hx (H<Hx), the detected contaminant forms a gray image with an unclear outline and tone gradation from the center to the outside. If the contaminant is in focus (H=Hx), it forms an image with a clear outline. If the focal distance is further shifted so that H becomes higher than Hx (H>Hx), the detected contaminant will form an image with an unclear outline and tone gradation from the center to the outside.

FIG. 5D shows the level of the output (brightness) from the CCD device along line α-α in FIG. 5C. If the focus position of the magnifier is on the contaminant (H=Hx), a large peak is formed in response to the contaminant. If the focus position is not on the contaminant (H≠Hx), only a small peak is formed. The output value from the CCD device changes as shown in FIG. 5D. Thus, the image processing program P2 is executed in synchronization with the shift of the focus position, so that the output value from each of the CCD devices arranged over the area is obtained. The number of the devices outputting a measurement value higher than the reference level TH is counted so that the area occupied by the contaminant(s) can be measured.

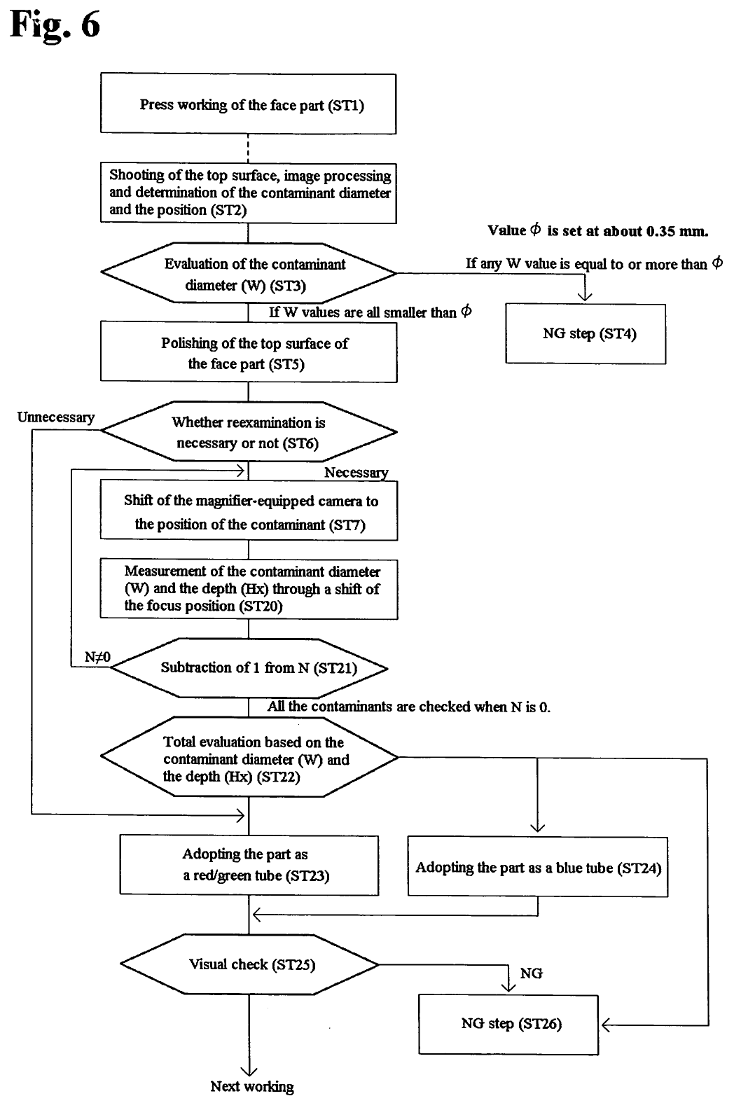

In this embodiment, therefore, the depth Hx where the contaminant is located is determined through the process of determining the instant when the measured area occupied by the contaminant becomes maximum (ST8). If the maximum vale of the area occupied by the contaminant is converted into an equivalent circle area, the equivalent diameter W of the contaminant can be obtained. In terms of simplification, however, the contaminant diameter W is not calculated in step ST8 of this embodiment. In step ST20 shown in FIG. 6, however, such a contaminant diameter W is calculated.

It is then evaluated whether any harmful contaminant is located in the region from the surface 1a of the fluorescent film of the face part 1 to the reference depth TS or not (ST9). If the contaminant is located in a region closer to the fluorescent film surface 1a than the reference depth TS, it should have a significant effect, and thus the face part containing such a contaminant is adopted as a part for a blue image, which is relatively not affected (ST10).

In this embodiment, the reference depth TS means a measured distance from the fluorescent film surface 1a in the light-travel direction, and is specifically set within the range of from about 2.6 to about 4.0 mm. The reference depth TS is determined based on the finding that the contaminant in a certain range close to the surface 1a of the fluorescent film of the face part 1 has an adverse effect on the image projected on the screen. As a result of further investigations, it has been found that the contaminant at a depth (a) at least ranging from that of the fluorescent film surface to 2.6 mm, (b) preferably ranging from that of the fluorescent film surface to 4.0 mm should strictly be monitored or managed. The reference depth is also determined based on this finding.

As shown above, the face part containing a contaminant in the region closer to the fluorescent film surface 1a than the reference depth TS is adopted as a part for a blue image. If the contaminant in the face part is not located in the region to the reference depth TS, the face part can be adopted as a part for a red or green image. However, any other contaminant unmeasured for depth should be examined. Thus, 1 is subtracted from the counter value N for the number of the unmeasured contaminants, and if N≠0, the face part is subjected to step ST7. In the process including step ST7 and subsequent steps, therefore, the same face part is measured for the depth of any other contaminant.

After these steps are repeated, all the contaminants in the face part are measured for depth. If it is evaluated that the face part has no harmful contaminant in the region from the fluorescent film surface 1a to the reference depth TS, the face part is adopted as a part for a red or green image (ST12). Finally, a visual inspection is made (ST13), and if something unusual is found, the face part is subjected to the NG step, and if not, the face part is subjected to the next step of completing a glass bulb for use in a cathode-ray tube.

In the example embodiment with reference to FIG. 1, the contaminant diameter W is evaluated whether it exceeds the defective reference value φ or not, and then the part containing a detected contaminant with a value exceeding the defective reference value φ is uniformly subjected to the NG step (ST3). Only the part with W<φ is then subjected to the depth evaluation (ST9), and the part containing the contaminant in the region closer to the fluorescent film surface 1a than the reference depth TS is adopted as a part for a blue image, and only the part containing no contaminant in the region closer to the fluorescent film surface 1a than the reference depth TS is adopted as a part for a red or green image.

Even if the adopted part for the red or green image could contain a certain contaminant in the region closer to the fluorescent film surface 1a than the reference depth TS, such a contaminant would be so fine that it could not be measured by the simplified measurement in step ST2, and therefore would not affect the image projected on the screen.

FIG. 6 is a flowchart showing a second embodiment of the invention, in which the quality control is performed in a more sophisticated manner. Basically, this embodiment includes the steps ST1 to ST7 similarly to the case as shown in FIG. 1. However, the defective reference value φ is uniformly set at about 0.35 mm in this embodiment, while the value φ is set at any value in the range from 0.15 to 0.35 mm in the first embodiment. Thus, the face part rejected as defective in the first embodiment is not necessarily subjected to the NG step in this embodiment. This is because in this embodiment, the defective/non-defective evaluation is made in a more sophisticated manner depending on the contaminant diameter W and the depth Hx of the contaminant.

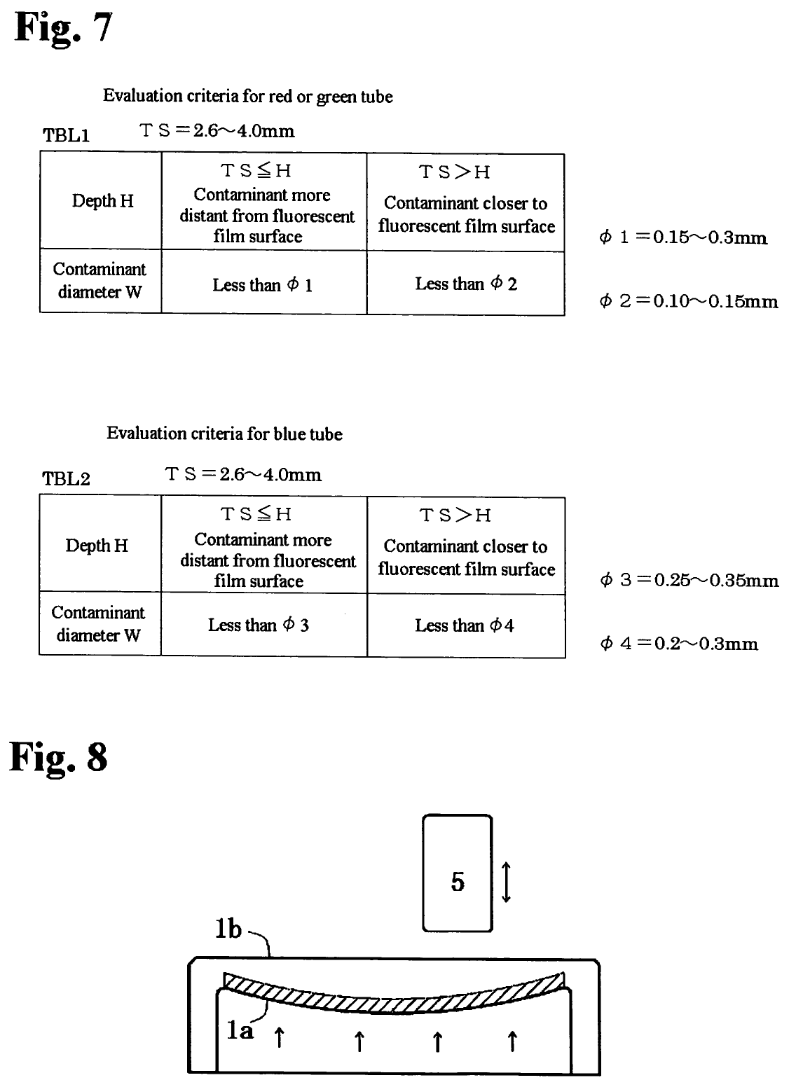

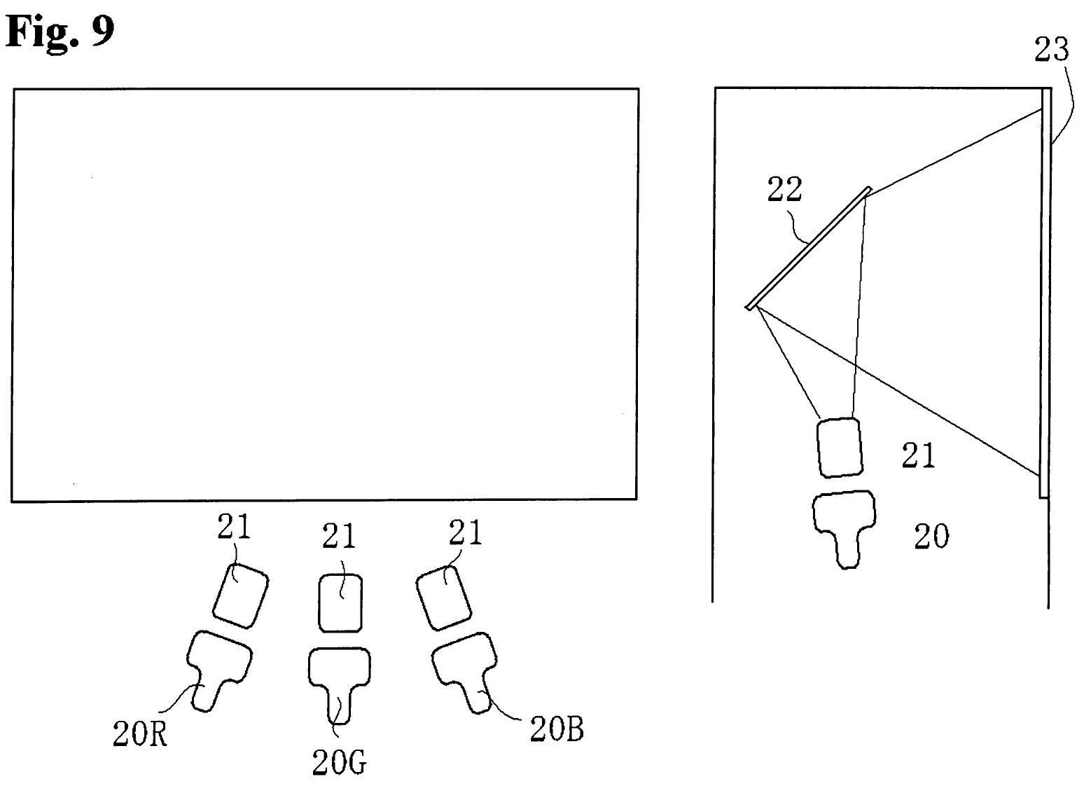

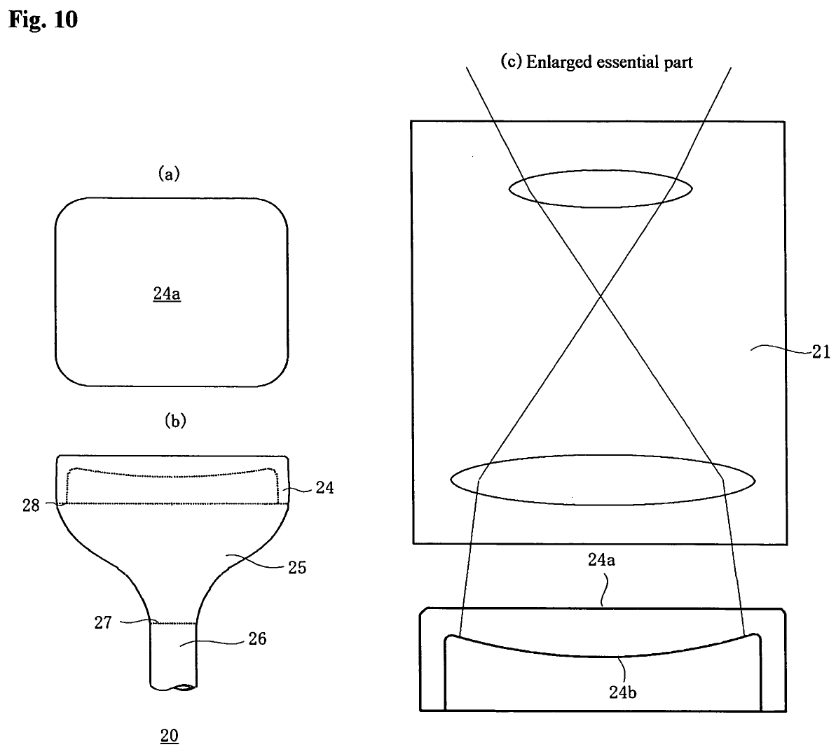

In this embodiment having such features, all the contaminants detected in step ST2 are uniformly measured for the contaminant diameter W and the depth Hx (ST7, ST20 and ST21). Based on evaluation tables such as TBL1 and TBL2 in FIG. 7, thereafter, the defective/non-defective evaluation is made using the contaminant diameter and the depth as parameters (ST22).

If the contaminant in a region more distant from the fluorescent film surface 1a than the reference depth TS has a contaminant diameter W of smaller than a first reference value φ1 and if the contaminant in a region closer to the fluorescent film surface 1a than the reference depth TS has a contaminant diameter W of smaller than a second reference value φ2 (see TBL1 in FIG. 7), the face part may be adopted as a part for a red or green image. Herein, the first and second reference values φ1 and φ2 should each be set at a certain value. As a result of experiments, the inventors have found that φ1 is preferably from about 0.15 to about 0.3 mm and that φ2 is preferably from about 0.10 to about 0.15 mm.

If the contaminant in a region more distant from the fluorescent film surface 1a than the reference depth TS has a contaminant diameter W of smaller than a third reference value φ3 and if the contaminant in a region closer to the fluorescent film surface 1a than the reference depth TS has a contaminant diameter W of smaller than a fourth reference value φ4 (see TBL2 in FIG. 7), the face part may be adopted as a part for a blue image. Herein, the third and fourth reference values φ3 and φ4 should each be set at a certain value. As a result of experiments, the inventors have found that φ3 is preferably from about 0.25 to about 0.35 mm and that φ4 is preferably from about 0.2 to about 0.3 mm.

In this embodiment, the face part, which would otherwise be rejected in the first embodiment, may not be rejected depending on the position of the contaminant, so that the yield in production can be increased. If the face part satisfies neither the requirements in TBL1 nor those in TBL2, it may be subjected to a NG step (ST26).

The invention is specifically described in the above two embodiments, but such a specific description is not intended to limit the scope of the invention. In the above embodiments, the contaminant diameter of the target contaminant is determined through a physical shift of the focus position of the magnifier. However, such a method is not essential. Alternatively, for example, the region from the fluorescent film surface to the reference depth TS may preferably be in focus so that the depth evaluation can be expedited. In such a case, for example, a magnifier-equipped camera may be used in step ST2 as shown in FIG. 1 or 6, so that the defective/non-defective evaluation can be completed only in step ST2. While the above embodiments use a fully automatic system, they are not intended to exclude a manual operation.

It is further understood by those skilled in the art that the foregoing description is a preferred embodiment of the disclosed device and that various changes and modifications may be made in the invention without departing from the sprit and scope thereof

1. A glass bulb for use in a cathode-ray tube for a projection TV for forming a red or green image, comprising a face part having a fluorescent film, wherein
the face part includes: a light-transmitting region that contains no contaminant having an effective diameter W of at least a defective reference value φ; and a region extending from the surface of the fluorescent film in the light-travel direction, which is located within a reference depth TS and only contains a contaminant having an effective diameter W of at most a measurement reference value φ′, and
the defective reference value φ is from 0.15 mm to 0.35 mm; the measurement reference value φ′ is from 0.07 mm to 0.15 mm; and the reference depth TS is from 2.6 mm to 4.0 mm.

2. A glass bulb for use in a cathode-ray tube for forming a blue image and for use in combination with the glass bulb according to claim 1, comprising a face part whose light-transmitting region contains no contaminant having an effective diameter W of at least a defective reference value φ, wherein
the defective reference value φ is from 0.15 mm to 0.35 mm.

3. A glass bulb for use in a cathode-ray tube for a projection TV for forming a red or green image, comprising a face part having a fluorescent film, wherein
the face part includes: a light-transmitting region that contains no contaminant having an effective diameter W of at least a first reference value φ1; and a region extending from the surface of the fluorescent film in the light-travel direction, which is located within a reference depth TS and contains no contaminant having an effective diameter W of at least a second reference value φ2, and
the first reference value φ1 is from 0.15 mm to 0.3 mm; the second reference value φ2 is from 0.10 mm to 0.15 mm; and the reference depth TS is from 2.6 mm to 4.0 mm.

4. A glass bulb for use in a cathode-ray tube for a projection TV for forming a blue image, comprising a face part having a fluorescent film, wherein
the face part includes: a light-transmitting region that contains no contaminant having an effective diameter W of at least a third reference value φ3; and a region extending from the surface of the fluorescent film in the light-travel direction, which is located within a reference depth TS and contains no contaminant having an effective diameter W of at least a fourth reference value φ4, and
the third reference value φ3 is from 0.25 mm to 0.35 mm; the fourth reference value φ4 is from 0.2 mm to 0.3 mm provided that φ4 is smaller than φ3; and the reference depth TS is from 2.6 mm to 4.0 mm.

5. A method of manufacturing a glass bulb for use in a cathode-ray tube for a projection TV, comprising:
a first step of determining the size of a contaminant in a light-transmitting region of a face part of the glass bulb and determining the position of the contaminant in a two-dimensional coordinate system;
a second step of searching, in another coordinate direction, the contaminant located in the two-dimensional coordinate system, in order to determine the depth position of the contaminant in a three-dimensional coordinate system; and
a third step of determining the use of the face part based on the determined depth position.

6. A method of manufacturing a glass bulb for use in a cathode-ray tube for a projection TV, comprising:
a first step of approximately determining the size of a contaminant in a light-transmitting region of a face part of the glass bulb and determining the position of the contaminant in a two-dimensional coordinate system;
a second step of searching, in another coordinate direction, the contaminant located in the two-dimensional coordinate system, in order to determine the depth position of the contaminant in a three-dimensional coordinate system and to precisely determine the size of the contaminant; and
a third step of determining the use of the face part based on the determined depth position and the precisely determined size.
